(19) United States
(12) Patent Application Publication
(10) Pub. No.: US 2016/0124743 A1
(43) Pub. Date: May 5, 2016

(54) COMPATIBILITY AND OPTIMIZATION OF WEB APPLICATIONS ACROSS INDEPENDENT APPLICATION STORES

(71) Applicant: Richard R. Winterton, Provo, UT (US)

(72) Inventor: Richard R. Winterton, Provo, UT (US)

(21) Appl. No.: 14/124,771

(22) PCT Filed: Jun. 28, 2013
(86) PCT No.: PCT/US2013/048441

§ 371 Date: Dec. 9, 2013

(51) Int. Cl. G06F 9/44; H04L 29/08

(52) U.S. Cl. CPC G06F 8/71; H04L 67/02; G06F 8/76

(57) ABSTRACT

Systems and methods may provide for identifying a set of configuration options associated with a plurality of different application stores and using the set of configuration options to generate one or more compatibility suggestions for a web application in a development environment. Additionally, the set of configuration options may be used to generate one or more optimization suggestions for the web application in the development environment, wherein the one or more compatibility suggestions and the one or more optimization suggestions may be specific to a particular application store in the plurality of different application stores. In one example, runtime information associated with web application is identified, wherein the runtime information is used to generate at least one of the one or more optimization suggestions.

### TECHNICAL FIELD

Embodiments generally relate to web application development. More particularly, embodiments relate to the compatibility and optimization of web applications across independent application stores.

### BACKGROUND

Browser and web application developers may typically write source code in higher level languages such as JAVASCRIPT, HTML (hypertext markup language), CSS (cascading style sheets), etc., in order to provide enhanced functionality to the end user. In addition, web applications may be made available to end users for download via different application stores, wherein each application store may have specific platform and/or operating system (OS) requirements. Customizing the high level language of the web application to the requirements of each application store may present significant challenges.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a web application development environment according to an embodiment;

FIG. 2 is a flowchart of an example of a method of developing web applications according to an embodiment;

FIG. 3 is a block diagram of an example of a logic architecture according to an embodiment;

FIG. 4 is a block diagram of an example of a software stack according to an embodiment;

FIG. 5 is a block diagram of an example of a processor according to an embodiment; and

FIG. 6 is a block diagram of an example of a system according to an embodiment.

### DESCRIPTION OF EMBODIMENTS

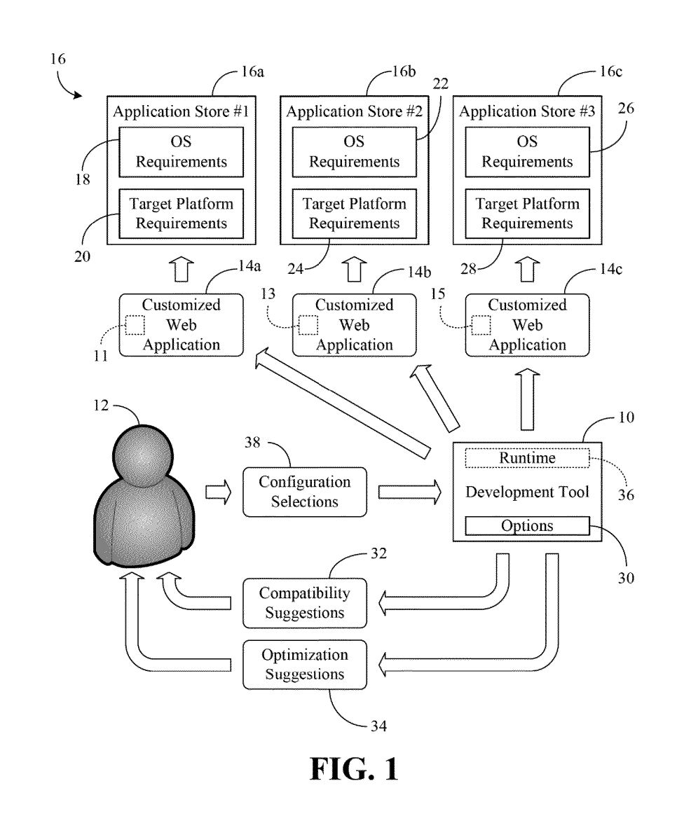

Turning now to FIG. 1, a web application development environment is shown in which a programmer 12 uses a development tool 10 to create customized web applications 14 (14a-14c) for various different application stores 16 (16a-16c). The customized web applications 14 may be written in one or more high level languages such as, for example, JAVASCRIPT, HTML and/or CSS, wherein each application store 16 may have different OS requirements and/or target platform requirements 24. For example, a first application store (“Application Store #1”) may generally be dedicated to MICROSOFT compliant applications having WINDOWS Store-related OS requirements 18 and target platform requirements 20, a second application store (“Application Store #2”) might generally be dedicated to GOOGLE compliant applications having ANDROID Play-related OS requirements 22 and target platform requirements, a third application store (“Application Store #3”) may generally be dedicated to APPLE compliant applications having ITUNES-related OS requirements 26 and target platform requirements 28, and so forth.

In the illustrated example, the development tool 10 identifies a set of configuration options 30 associated with the different application stores 16 and uses the options 30 to generate one or more compatibility suggestions 32 for the web applications 14 in the development environment. The development tool 10 may also use the options 30 to generate one or more optimization (e.g., performance and/or power) suggestions 34 for the web applications 14 in the development environment. The suggestions 32, 34, which may be either manually implemented by the programmer 12 or automatically implemented by the development tool 10, may be tailored to one or more high level programming languages of the web applications 14. For example, the suggestions 32, 34 may provide JAVASCRIPT, HTML and CSS alternatives that enable compatibility and optimization to be achieved.

As will be discussed in greater detail, the development tool 10 may also identify runtime information 36 (e.g., number of cache misses, number of pages misses, central processing unit/CPU utilization, etc.) associated with the web application, wherein the runtime information 36 may also be used to generate the optimization suggestions 34. Such an approach may be particularly advantageous, given that some JAVASCRIPT code may be translated and executed on-the-fly (e.g., just in time/JIT processing). In particular, the runtime information 10 may be generated by one or more of the customized web applications 14 and used for subsequent versions, updates and/or releases of the web applications 14 (e.g., collected as statistical information if an end user opts in). For 14a, a second instrumentation library 13 may be incorporated into a second web application 14b, a third instrumentation library 15 may be incorporated into a third web application 14c, etc., wherein the instrumentation libraries 11, 13, 15 may generate the runtime information 36 and transmit the runtime information 36 back to the development tool 10 for future use.

The instrumentation libraries 11, 13, 15 may be compiled into the web applications 14 according to the targeted platform. For example, the instrumentation libraries 11, 13, 15 may be in the form of bytecode that is incorporated into the ANDROID WEBVIEW interface, JAVASCRIPT specific APIs for the WinJs namespace in the WINDOWS 8 user interface (UI), JAVASCRIPT bytecode or LLVM bytecode for iOS applications, and so forth. As the programmer 12 makes configuration selections 38, the development tool 10 may generate the web applications 14 based on those selections 38, as well as the OS requirements and/or target platform requirements of the application stores 16. Thus, rather than merely placing platform-specific wrappers around the web applications 14, the illustrated approach provides a more flexible solution from the perspective of the programmer 12.

For example, the compatibility suggestions 32 may enable the programmer 12 to ensure that the customized web applications 14 are compliant with any API or other requirements of the application stores 16. The optimization suggestions 34 may extend beyond the compatibility suggestions 32 by addressing performance and/or power considerations. More particularly, the optimization suggestions 34 might identify, for example, CSS file organizations (e.g., style and/or special effects such as transition settings, swipe settings, fade settings, etc.), JavaScript file organizations, application programming interface (API) selections, still image formats, timeout settings, video codec selections, video formats, and so forth, that balance performance against power for the specific web application, OS and/or target platform.

For example, CSS may generally enable the separation of document content (written in HTML or a similar markup language) from document presentation, including elements such as the layout, colors, and fonts. The processing and rendering of CSS elements may be dependent on the number of items and styles that are used. Indeed, certain high performance features such as CSS transitions and fades that are implemented by HTML5 (Hypertext Markup Language 5, e.g., HTML5 Editor's Draft 8 May 2012, W3C) may use significant power on the platform. In such a case, an optimization suggestion 34 might be to change the rate at which CSS transforms and/or fades are conducted, or forego the use of CSS transitions and/or fades altogether if they are not closely tied to the performance of the web application.

In another example, a particular OS (e.g., WINDOWS 8) may include some user experience (UX) APIs that are recommended and others that are provided but not recommended. As the programmer 12 uses APIs, alternative APIs might be suggested. Thus, the development tool 10 may suggest, for example, the use of the “requestAnimationFrame” API for page refreshes during the application development process as an optimization suggestion 34. Additionally, particular JAVASCRIPT APIs may be suggested in order to minimize the amount of code that is written to a specific platform and/or application store. The suggested JAVASCRIPT APIs may be kept primarily non-platform specific, with parameters being added to the extent required by a given platform. Additionally, there may be suggestions by the development tool 10 that will make it easier for the JAVASCRIPT engines to generate more optimized code. Such an approach may increase flexibility while at the same time facilitating the acceptance of the web application across multiple application stores.

Moreover, still image formats may impact power and/or performance. For example, PNG (Portable Network Graphics) files are typically larger than JPG (Joint Photographic Experts Group) files and may involve more power to transmit and render. On the other hand, PNG files contain an alpha channel that enables specific colors to be made transparent, whereas JPG file do not have an alpha channel. Thus, if the development tool 10 determines that the web application does not make use of the alpha channel, an optimization suggestion 34 might recommend that the programmer 12 switch from using the PNG file format to the JPG file format for still image rendering.

In yet another example, the development tool 10 may determine that a timeout setting (e.g., setTimeout) has been configured to a relatively small value (e.g., 1 ms) that may have a negative impact on battery life without improving performance. In such a case, an optimization suggestion 34 may recommend that the timeout setting be increased. Other examples of the optimization suggestions 34 include, but are not limited to, recommending particular video codecs and/or video formats based on whether hardware acceleration is implemented on the target platform, what type of hardware is present on the target platform, and so forth.

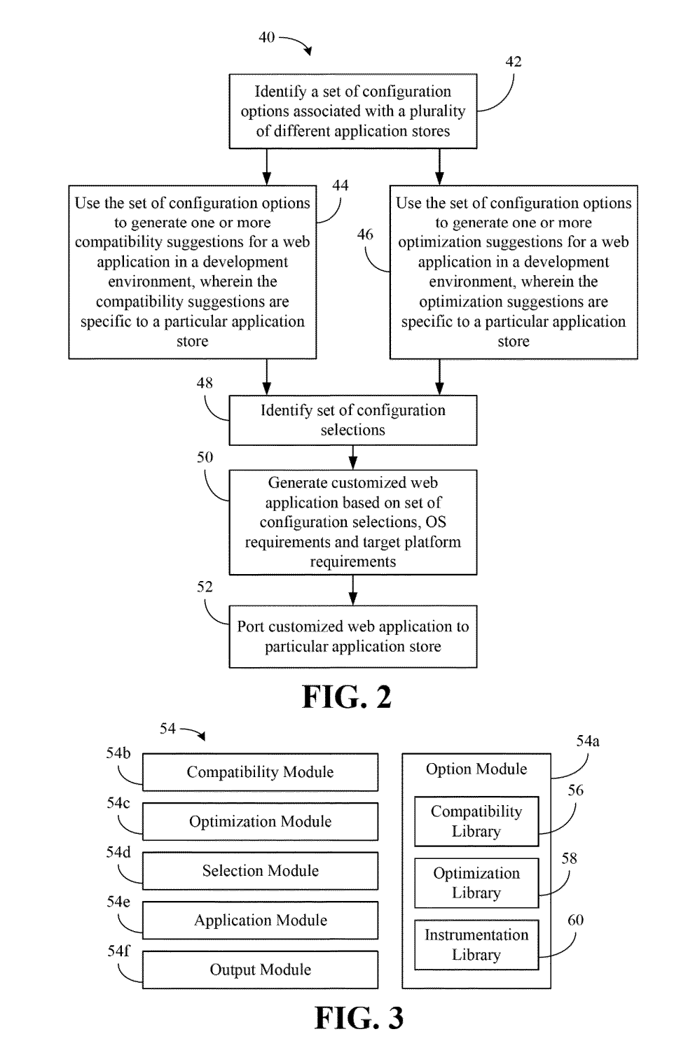

Turning now to FIG. 2, a method 40 of developing web applications is shown. The method 40 may be implemented as a set of logic instructions and/or firmware stored in a machine- or computer-readable medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 40 may be written in any combination of one or more programming languages, including an object oriented programming language such as C++ or the like and conventional procedural programming languages, such as the “C” programming language or similar programming languages. Moreover, the method 40 may be implemented using any of the aforementioned circuit technologies.

Illustrated processing block 42 provides for identifying a set of configuration options associated with a plurality of different application stores. As will be discussed in greater detail, the configuration options may be implemented as a set of libraries. The set of configuration options may be used at block 44 to generate one or more compatibility suggestions for a web application in a development environment, wherein the compatibility suggestions are specific to a particular application store in the plurality of different application stores. Additionally, illustrated block 46 uses the set of configuration options to generate one or more optimization suggestions for the web application in the development environment. The optimization suggestions may also be specific to the particular application store. As already noted, at least one of the one or more optimization suggestions may address a performance consideration and/or a power consideration.

A set of configuration selections may be identified at block 48, wherein illustrated block 50 generates a customized web application based on the set of configuration selections, one or more OS requirements of the particular application store, one or more target platform requirements of the particular application store, and so forth. Block 50 may involve incorporating an instrumentation library into the web application, wherein the instrumentation library identifies runtime information that may also be used to generate the optimization suggestions. The customized web application may be ported to the particular application store at block 52.

FIG. 3 shows a development tool logic architecture 54 (54a-54f) that may be used to develop web applications. In the illustrated example, an option module 54a identifies a set of configuration options for a plurality of different application stores. The set of configuration options may be embodied in a compatibility library 56, an optimization library 58 and/or an instrumentation library 60. The compatibility library 56 may support HTML, JAVASCRIPT and CSS compliance with various user, web and/or browser interfaces such as, for example, the WINDOWS 8 UI JAVASCRIPT Interface, ANDROID HTML web interface, iOS HTML web interface, IE (Internet Explorer) browser interface, FIREFOX browser interface, CHROME browser interface, SAFARI browser interface, and so forth. The illustrated compatibility library 56 may work in conjunction with a compatibility module 54b of a customization layer (to be discussed in greater detail) to generate compatibility suggestions for web applications in a development environment.

In addition, the optimization library 58 may work in conjunction with an optimization module 54c of the customization layer to generate optimization suggestions for the web applications in the development environment. As already noted, the optimization suggestions may address performance considerations and/or power considerations. In one example, the optimization suggestions may identify CSS file organizations (e.g., style effects, special effects, transition settings, swipe settings, fade settings, etc.), JAVASCRIPT file organizations, API selections, still image formats, video codec selections, video formats, etc., or any combination thereof. The instrumentation library 60, which may also be incorporated into the web applications, may identify runtime information associated with the web applications, wherein the runtime information may also be used to generate one or more optimization suggestions. The instrumentation library 60 may include, for example, VTUNE software performance analysis functionality, SEP (Sampling Enabling Product) functionality, etc. as well as various HTML, CSS and JAVASCRIPT suggestion options.

The illustrated architecture 54 also includes a selection module 54d to identify a set of configuration selections, and an application module 54e to generate the web applications based on the set of configuration selections, one or more OS requirements of a particular application store, and one or more target platform requirements of the particular application store. In addition, an output module 54f may port the web application to the particular application store.

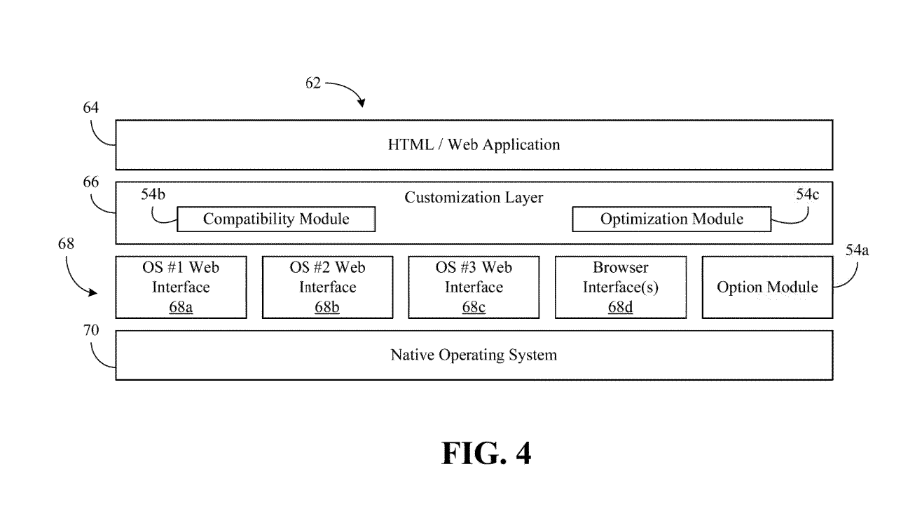

Turning now to FIG. 4, a software stack 62 is shown in which a web application layer 64 written in a high level language is above a customization layer 66 that contains the compatibility module 54b and the optimization module 54e. The illustrated customization layer 66 is above a set of interfaces 68 (68a-68d) and the options module 54a, which may contain various libraries to facilitate the generation of compatibility suggestions as well as optimization suggestions. The customization layer 66 may therefore function as a performance-power balancer and compatibility analyzer with respect to high level source code such as, for example, JAVASCRIPT, HTML and CSS code. Each interface 68 may be specific to a particular type of OS and/or browser (e.g., WINDOWS 8 UI JAVASCRIPT Interface, ANDROID HTML web interface, iOS HTML web interface, IE browser interface, FIREFOX browser interface, CHROME browser interface, SAFARI browser interface). A native OS 70 layer may reside beneath the interfaces 68 and the option module 54a.

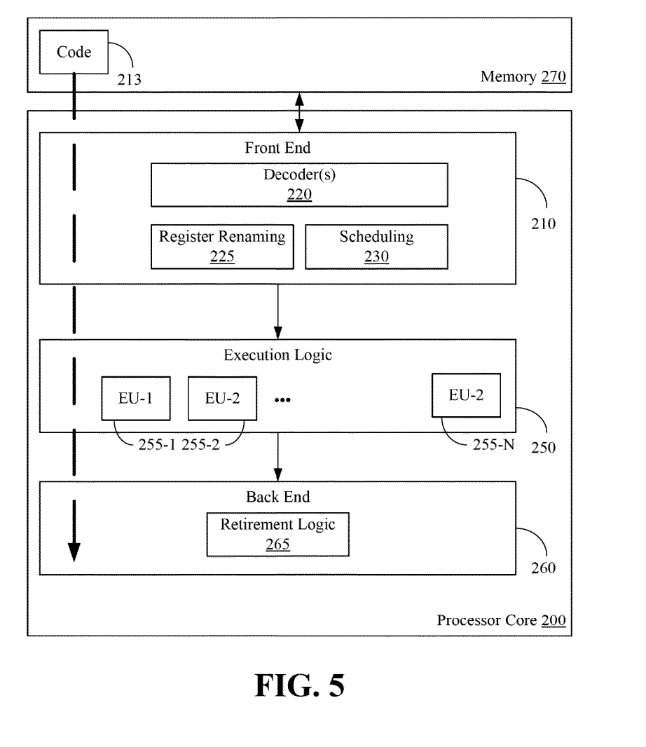

FIG. 5 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the method 40 (FIG. 2) and/or logic architecture 54 (FIG. 3), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

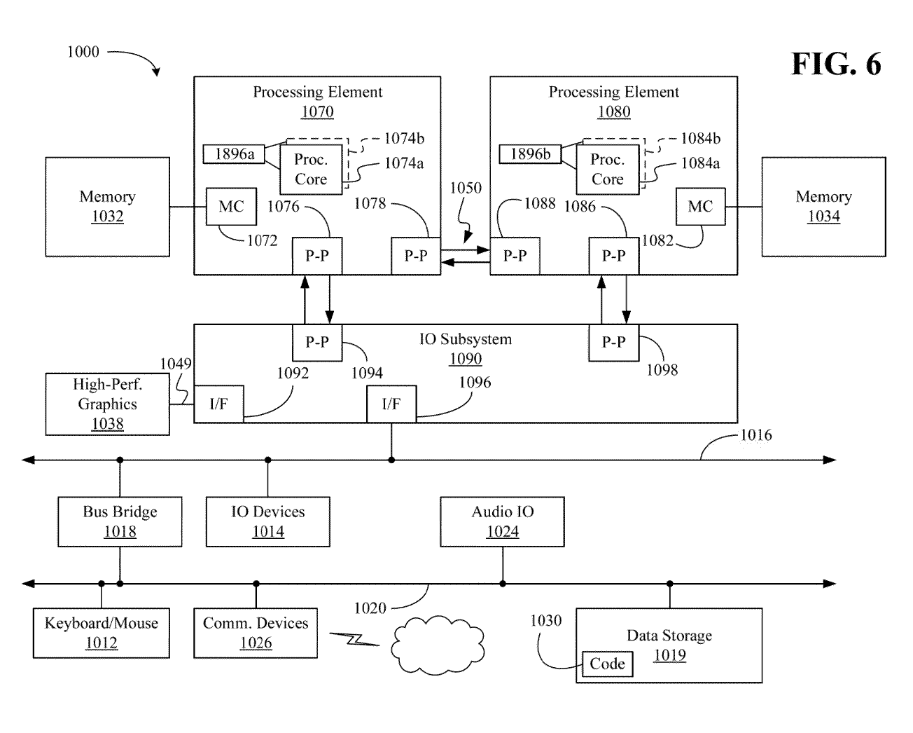

Referring now to FIG. 6, shown is a block diagram of a system 1000 embodiment in accordance with an embodiment. Shown in FIG. 6 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 5.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same the package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an subsystem 1090 via P-P interconnects 1076, 1086, respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation interconnect bus, although the scope of the embodiments are not so limited.

As shown in FIG. 6, various I/O devices 1014 (e.g., cameras) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers:communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method 40 (FIG. 2) and/or logic architecture 54 (FIG. 3), and may be similar to the code 213 (FIG. 5), already discussed. Further, an audio I/O 1024 may be coupled to second bus 1020.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

Additional Notes and Examples:

Example 1 may include an apparatus to develop web applications, comprising an option module to identify a set of configuration options associated with a plurality of different application stores and a compatibility module to use the set of configuration options to generate one or more compatibility suggestions for a web application in a development environment. The apparatus may also include an optimization module to use the set of configuration options to generate one or more optimization suggestions for the web application in the development environment, wherein the one or more compatibility suggestions and the one or more optimization suggestions are to be specific to a particular application store in the plurality of different application stores.

Example 2 may include the apparatus of Example 1, further including an instrumentation library to identify runtime information associated with the web application, wherein the runtime information is to be used to generate at least one of the one or more optimization suggestions.

Example 3 may include the apparatus of Example 2, wherein the option module is to incorporate the instrumentation library into the web application.

Example 4 may include the apparatus of Example 1, wherein at least one of the one or more optimization suggestions is to address one or more of a performance consideration or a power consideration.

Example 5 may include the apparatus of Example 1, wherein at least one of the one or more optimization suggestions identifies one or more of a cascading style sheets (CSS) file organization, a JavaScript file organization, an application programming interface (API) selection, a still image format, a timeout setting, a video codec selection or a video format.

Example 6 may include the apparatus of Example 5, wherein the CSS file organization is to include one or more of a style effect, a special effect, a transition setting, a swipe setting or a fade setting.

Example 7 may include the apparatus of any one of Examples 1 to 6, further including a selection module to identify a set of configuration selections, and an application module to generate the web application based on the set of configuration selections, one or more operating system requirements of the particular application store and one or more target platform requirements of the particular application store.

Example 8 may include the apparatus of Example 7, further including an output module to port the web application to the particular application store.

Example 9 may include the apparatus of any one of Examples 1 to 6, wherein the option module includes a compatibility library and an optimization library.

Example 10 may include a method of developing web applications, comprising identifying a set of configuration options associated with a plurality of different application stores and using the set of configuration options to generate one or more compatibility suggestions for a web application in a development environment. The method may also involve using the set of configuration options to generate one or more optimization suggestions for the web application in the development environment, wherein the one or more compatibility suggestions and the one or more optimization suggestions are specific to a particular application store in the plurality of different application stores.

Example 11 may include the method of Example 10, further including identifying runtime information associated with the web application, wherein the runtime information is used to generate at least one of the one or more optimization suggestions.

Example 12 may include the method of Example 11, further including incorporating an instrumentation library into the web application, wherein the instrumentation library identifies the runtime information.

Example 13 may include the method of Example 10, wherein at least one of the one or more optimization suggestions addresses one or more of a performance consideration or a power consideration.

Example 14 may include the method of Example 10, wherein at least one of the one or more optimization suggestions identifies one or more of a cascading style sheets (CSS) file organization, a JavaScript file organization, an application programming interface (API) selection, a still image format, a timeout setting, a video codec selection or a video format.

Example 15 may include the method of Example 14, wherein the CSS file organization includes one or more of a style effect, a special effect, a transition setting, a swipe setting or a fade setting.

Example 16 may include the method of any one of Examples 10 to 15, further including identifying a set of configuration selections, and generating the web application based on the set of configuration selections, one or more operating system requirements of the particular application store and one or more target platform requirements of the particular application store.

Example 17 may include the method of Example 16 further including porting the web application to the particular application store.

Example 18 may include at least one computer readable storage medium comprising a set of instructions which, if executed by a computing device, cause the computing device to identify a set of configuration options associated with a plurality of different application stores and use the set of configuration options to generate one or more compatibility suggestions for a web application in a development environment. The instructions, if executed, may also cause a computing device to use the set of configuration options to generate one or more optimization suggestions for the web application in the development environment, wherein the one or more compatibility suggestions and the one or more optimization suggestions are to be specific to a particular application store in the plurality of different application stores.

Example 19 may include the at least one computer readable storage medium of Example 18, further including an instrumentation library to identify runtime information associated with the web application, and wherein the runtime information is to be used to generate at least one of the one or more optimization suggestions.

Example 20 may include the at least one computer readable storage medium of Example 19, wherein the instructions, if executed, cause a computing device to incorporate the instrumentation library into the web application.

Example 21 may include the at least one computer readable storage medium of Example 18, wherein at least one of the one or more optimization suggestions is to address one or more of a performance consideration or a power consideration.

Example 22 may include the at least one computer readable storage medium of Example 18, wherein at least one of the one or more optimization suggestions identifies one or more of a cascading style sheets (CSS) file organization, a JavaScript file organization, an application programming interface (API) selection, a still image format, a timeout setting, a video codec selection or a video format.

Example 23 may include the at least one computer readable storage medium of Example 22, wherein the CSS file organization is to include one or more of a style effect, a special effect, a transition setting, a swipe setting or a fade setting.

Example 24 may include the at least one computer readable storage medium of any one of Examples 18 to 23, wherein the instructions, if executed, cause a computing device to identify a set of configuration selections, and generate the web application based on the set of configuration selections, one or more operating system requirements of the particular application store and one or more target platform requirements of the particular application store.

Example 25 may include the at least one computer readable storage medium of Example 24, wherein the instructions, if executed, cause a computing device to port the web application to the particular application store.

Example 26 may include an apparatus to develop web application, comprising means for performing the method of any one of examples 10 to 17.

Techniques described herein may therefore provide developers a single flexible environment to develop web applications across platforms and across application stores. The configuration options and suggestions may be extended over time as technologies evolve and different development needs arise. The techniques may eliminate any need for programmers to write multiple different code bases in order for a web application to be accepted into different application stores. As a result, development time may be significantly reduced while enhancing power and/or performance through optimization suggestions.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (APIs), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size may be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing systems registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. An apparatus to develop web applications, comprising:
an option module to identify a set of configuration options associated with a plurality of different application stores;
a compatibility module to use the set of configuration options to generate one or more compatibility suggestions for a web application in a development environment; and
an optimization module to use the set of configuration options to generate one or more optimization suggestions for the web application in the development environment, wherein the one or more compatibility suggestions and the one or more optimization suggestions are to be specific to a particular application store in the plurality of different application stores.

27. The apparatus of claim 26, further including an instrumentation library to identify runtime information associated with the web application, wherein the runtime information is to be used to generate at least one of the one or more optimization suggestions.

28. The apparatus of claim 27, wherein the option module is to incorporate the instrumentation library into the web application.

29. The apparatus of claim 26, wherein at least one of the one or more optimization suggestions is to address one or more of a performance consideration or a power consideration.

30. The apparatus of claim 26, wherein at least one of the one or more optimization suggestions identifies one or more of a cascading style sheets (CSS) file organization, a JavaScript file organization, an application programming interface (API) selection, a still image format, a timeout setting, a video codec selection or a video format.

31. The apparatus of claim 30, wherein the CSS file organization is to include one or more of a style effect, a special effect, a transition setting, a swipe setting or a fade setting.

32. The apparatus of claim 26, further including:
a selection module to identify a set of configuration selections; and
an application module to generate the web application based on the set of configuration selections, one or more operating system requirements of the particular application store and one or more target platform requirements of the particular application store.

33. The apparatus of claim 32, further including an output module to port the web application to the particular application store.

34. The apparatus of claim 26, wherein the option module includes a compatibility library and an optimization library.

35. A method of developing web applications, comprising:
identifying a set of configuration options associated with a plurality of different application stores;
using the set of configuration options to generate one or more compatibility suggestions for a web application in a development environment; and
using the set of configuration options to generate one or more optimization suggestions for the web application in the development environment, wherein the one or more compatibility suggestions and the one or more optimization suggestions are specific to a particular application store in the plurality of different application stores.

36. The method of claim 35, further including identifying runtime information associated with the web application, wherein the runtime information is used to generate at least one of the one or more optimization suggestions.

37. The method of claim 36, further including incorporating an instrumentation library into the web application, wherein the instrumentation library identifies the runtime information.

38. The method of claim 35, wherein at least one of the one or more optimization suggestions addresses one or more of a performance consideration or a power consideration.

39. The method of claim 35, wherein at least one of the one or more optimization suggestions identifies one or more of a cascading style sheets (CSS) file organization, a JavaScript file organization, an application programming interface (API) selection, a still image format, a timeout setting, a video codec selection or a video format.

40. The method of claim 39, wherein the CSS file organization includes one or more of a style effect, a special effect, a transition setting, a swipe setting or a fade setting.

41. The method of claim 35, further including:
identifying a set of configuration selections; and
generating the web application based on the set of configuration selections, one or more operating system requirements of the particular application store and one or more target platform requirements of the particular application store.

42. The method of claim 41, further including porting the web application to the particular application store.

43. At least one computer readable storage medium comprising a set of instructions which, if executed by a computing device, cause the computing device to:
identify a set of configuration options associated with a plurality of different application stores;
use the set of configuration options to generate one or more compatibility suggestions for a web application in a development environment; and
use the set of configuration options to generate one or more optimization suggestions for the web application in the development environment, wherein the one or more compatibility suggestions and the one or more optimization suggestions are to be specific to a particular application store in the plurality of different application stores.

44. The at least one computer readable storage medium of claim 43, further including an instrumentation library to identify runtime information associated with the web application, and wherein the runtime information is to be used to generate at least one of the one or more optimization suggestions.

45. The at least one computer readable storage medium of claim 44, wherein the instructions, if executed, cause a computing device to incorporate the instrumentation library into the web application.

46. The at least one computer readable storage medium of claim 43, wherein at least one of the one or more optimization suggestions is to address one or more of a performance consideration or a power consideration.

47. The at least one computer readable storage medium of claim 43, wherein at least one of the one or more optimization suggestions identifies one or more of a cascading style sheets (CSS) file organization, a JavaScript file organization, an application programming interface (API) selection, a still image format, a timeout setting, a video codec selection or a video format.

48. The at least one computer readable storage medium of claim 47, wherein the CSS file organization is to include one or more of a style effect, a special effect, a transition setting, a swipe setting or a fade setting.

49. The at least one computer readable storage medium of claim 43, wherein the instructions, if executed, cause a computing device to:
identify a set of configuration selections; and
generate the web application based on the set of configuration selections, one or more operating system requirements of the particular application store and one or more target platform requirements of the particular application store.

50. The at least one computer readable storage medium of claim 49, wherein the instructions, if executed, cause a computing device to port the web application to the particular application store.
